(19) United States
(12) Patent Application Publication
(10) Pub. No.: US 2007/0154381 A1
(43) Pub. Date: Jul. 5, 2007

(54) Carbon foam with improved graphitizability

(76) Inventors: Douglas J. Miller, North Olmstead, OH (US); Irwin C. Lewis, Strongsville, OH (US); Richard L. Shao, North Royalton, OH (US); Terrence A. Pirro, Cleveland, OH (US)

Correspondence Address: WADDEY & PATTERSON, P.C., 1600 DIVISION STREET, SUITE 500, NASHVILLE, TN, 37203, US

(21) Appl. No.: 11/321,714

(22) Filed: Dec. 29, 2005

(51) Int. Cl. C01B 31/02; C01B 31/04

(52) U.S. Cl. 423/445 R; 423/448

(57) ABSTRACT

A carbon foam material with improved graphitizability is formed by including a graphitization promoting additive into the carbon foam. The graphitization promoting additive greatly improves the graphitic structure of the carbon foam resulting in a carbon foam with much greater thermal and electrical conductivities. This inventive foam may be created by introducing the graphitization promoting additive during the catalysis of a phenol-aldehyde mixture to a form phenolic resin or during the conversion of the phenolic resin to a phenolic foam. Alternatively, the graphitization promoting additive can be fixed onto a preformed carbon foam.

### BACKGROUND OF THE INVENTION

1. Technical Field

The present invention relates to graphitized carbon foams useful for high thermal and electrical conductivities, high temperature and/or high strength applications, such as heat conduction and dissipation, composite tooling, radar absorption and structural reinforcement. More particularly, the present invention relates to carbon foams exhibiting superior strength, weight and density characteristics while possessing improved graphitizability. The invention also includes methods for the production of such foams.

2. Background Art

Carbon foams have attracted considerable recent activity because of their properties of low density, coupled with either very high or low thermal conductivity. Conventionally, carbon foams are prepared via two general routes. Highly graphitizable foams have been produced by thermal treatment of mesophase pitches under high pressure. These foams tend to have high thermal and electrical conductivities. For example, in Klett, U.S. Pat. No. 6,033,506, mesophase pitch is heated while subjected to a pressure of 1000 psi to produce an open-cell foam containing interconnected cells with a size range of 90-200 microns. According to Klett, after heat treatment to 2800° C., the solid portion of the foam develops into a highly crystalline graphitic structure with an interlayer spacing of 0.366 nm. The foam is asserted to have compressive strengths greater than previous foams (3.4 MPa or 500 psi for a density of 0.53 g/cm³).

In Hardcastle et al. (U.S. Pat. No. 6,776,936), carbon foams with densities ranging from 0.68-1.5 g/cm³ are produced by heating a pitch in a mold at pressures up to 800 psi. The foam is alleged to be highly graphitizable and provide high thermal conductivity (250 W/m° K).

According to H. J. Anderson et al. in Proceedings of the 43rd International SAMPE Meeting, p. 756 (1998), carbon foam is produced from mesophase pitch followed by oxidative thermosetting and carbonization to 900° C. The foam has an open-cell structure of interconnected cells with varying shapes and with cell diameters ranging from 39 to greater than 480 microns.

Rogers et al., in Proceedings of the 45^{th} SAMPE Conference, p. 293 (2000), describe the preparation of carbon foams from coal-based precursors by heat treatment under high pressure to produce foam materials with densities of 0.35-0.45 g/cc and compressive strengths of 2000-3000 psi (thus a strength/density ratio of about 6000 psi/(g/cm³)). These foams have an open-cell structure of interconnected cells with cell sizes ranging up to 1000 microns. Unlike the mesophase pitch-derived foams described above, the coal-based foams are not highly graphitizable. In a recent publication, the properties of this type of foam were described (High Performance Composites, September 2004, p. 25). The foam has a compressive strength of 800 psi at a density of 0.27 g/cm³ or a strength-to-density ratio of 3000 psi/(g/cm³).

Stiller et al. (U.S. Pat. No. 5,888,469) describe production of carbon foam by pressure heat treatment of a hydrotreated coal extract. These materials are claimed to have high compressive strengths of 600 psi for densities of 0.2-0.4 g/cm³ (strength/density ratio of 1500-3000 psi/(g/cm³)). It is suggested that these foams are stronger than those having a glassy carbon or vitreous nature, which are not graphitizable.

Carbon foams can also be produced by direct carbonization of polymers or polymer precursor blends. Mitchell, in U.S. Pat. No. 3,302,999, discusses preparing carbon foams by heating a polyurethane foam at 200-255° C. in air followed by carbonization in an inert atmosphere at 900° C. These foams have densities of 0.085-0.387 g/cm³ and compressive strengths of 130-2040 psi (ratio of strength/density of 1529-5271 psi/(g/cm³)).

In U.S. Pat. No. 5,945,084, Droege describes the preparation of open-cell carbon foams by heat treating organic gels derived from hydroxylated benzenes and aldehydes (phenolic resin precursors). The foams have densities of 0.3-0.9 g/cm³ and are composed of small mesopores with a size range of 2 to 50 nm.

Mercuri et al. (Proceedings of the 9^{th} Carbon Conference, p. 206 (1969)) prepare carbon foams by pyrolysis of phenolic resins. For foams with a density range of 0.1-0.4 g/cm³, the compressive strength-to-density ratios are 2380-6611 psi/(g/cm³). The cells are ellipsoidal in shape with cell sizes of 25-75 microns for a carbon foam with a density of 0.25 g/cm³.

Stankiewicz (U.S. Pat. No. 6,103,149) prepares carbon foams with a controlled aspect ratio range of 0.6-1.2. The patentee points out that users often require a completely isotropic foam for superior properties with an aspect ratio of 1.0 being ideal. An open-cell carbon foam is produced by impregnation of a polyurethane foam with a carbonizable resin, followed by thermal curing and carbonization. The cell aspect ratio of the original polyurethane foam is thus changed from 1.3-1.4 to 0.6-1.2.

Unfortunately, many of the prior art processes for producing carbon foam are not effective for many applications where higher thermal conductivity is necessary so that heat can be more rapidly removed during processing. Generally, the most economical and convenient method of producing carbon foam is to directly carbonize a precursor foam derived from either phenolic or polyurethane resin. These resins are known to produce a non-graphitizable, glassy carbon, which have low thermal and electrical conductivities. Thus, the prior art carbon foam structures are not suitable for commercial applications where higher thermal and electrical conductivities are required.

What is desired, therefore, is a graphitizable carbon foam which is monolithic and has a controllable cell structure, where the cell structure, strength and strength-to-density ratio make the foam suitable for use as composite tooling as well as in other high temperature applications. Indeed, a combination of characteristics, including improved graphitizability and strength-to-density ratios higher than those contemplated in the prior art, have been found to be necessary for use of a carbon foam in high temperature and strength applications. Also desired is a process for preparing such foams.

### SUMMARY OF THE INVENTION

The present invention provides a carbon foam which exhibits improved graphitizability, density, compressive strength and compressive strength to density ratio to provide a combination of strength, conductivity and relatively light weight characteristics not heretofore seen. In addition, the monolithic nature and bimodal cell structure of the foam, with a combination of larger and smaller cells, which are relatively spherical, provide a carbon foam which can be produced in a desired size and configuration and which can be readily machined.

More particularly, the inventive carbon foam has a density of about 1 to about 40 pounds per cubic foot (lb/ft³) (i.e., about 0.02 to about 0.6 gram per cubic centimeter (g/cm³)), with a compressive strength of at least about 2000 pounds per square inch (psi) (measured by, for instance, the ASTM C695 method). An important characteristic for the foam when intended for use in a high temperature application is the ratio of compressive strength to density. For such applications, a ratio of strength to density of at least about 7000 psi/(g/cm³) is required, more preferably at least about 8000 psi/(g/cm³).

The inventive carbon foam should have a relatively uniform distribution of cells in order to provide the required high compressive strength. In addition, the cells should be relatively isotropic, by which is meant that the cells are relatively spherical, meaning that the cells have, on average, an aspect ratio of between about 1.0 (which represents a perfect spherical geometry) and about 1.5. The aspect ratio is determined by dividing the longer dimension of any cell with its shorter dimension.

The foam should have a total porosity of about 50% to about 95%, more preferably about 60% to about 95%. In addition, it has been found highly advantageous to have a bimodal cell size distribution, that is, a combination of two average cell sizes, with the primary fraction being the larger size cells and a minor fraction of smaller size cells. Preferably, of the cells, at least about 90% of the cell volume, more preferably at least about 95% of the cell volume should be the larger size fraction, and at least about 1% of the cell volume, more preferably from about 2% to about 10% of the cell volume, should be the smaller size fraction.

The larger cell fraction of the bimodal cell size distribution in the inventive carbon foam should be about 10 to about 150 microns in diameter, more preferably about 15 to about 95 microns in diameter, most preferably about 25 to about 95 microns in diameter. The smaller fraction of cells should comprise cells that have a diameter of about 0.8 to about 3.5 microns, more preferably about 1 to about 2 microns. The bimodal cell structure nature of the inventive foams provides an intermediate structure between open-cell foams and completely closed-cell foams, thus limiting the fluid permeability of the foam while maintaining a foam structure. Indeed, advantageously, the inventive carbon foams should exhibit a nitrogen gas permeability of no greater than about 3.0 darcys, more preferably no greater than about 2.0 darcys (as measured, for instance, by the ASTM C577 method).

Advantageously, to produce the inventive foams, a polymeric foam block, particularly a phenolic foam block, is carbonized in an inert or air-excluded atmosphere, at temperatures which can range from about 500° C., more preferably at least about 800° C., up to about 3200° C. to prepare carbon foams useful in high temperature applications.

An object of the invention is to provide a carbon foam having improved graphitizing characteristics which enables it to be employed for commercial applications where a higher thermal conductivity is desired.

Another object of the invention, therefore, is a monolithic carbon foam having characteristics that enable it to be employed in high temperature applications such as in composite tooling.

Yet another object of the invention is a carbon foam having improved graphitizability, density, compressive strength and ratio of compressive strength to density sufficient for high temperature applications.

Still another object of the invention is a carbon foam having a porosity and cell structure and size distribution to provide utility in applications where highly connected porosity is undesirable.

Yet another object of the invention is a carbon foam which can be produced in a desired block size and configuration, and which can be readily machined or joined to provide larger carbon foam structures.

Another object of the invention is to provide a method of producing the inventive carbon foam.

These aspects and others that will become apparent to the artisan upon review of the following description can be accomplished by providing a carbon foam article produced using a polymeric foam, such as a phenolic resol, formed by polymerization in the presence of a graphitization promoting additive selected to improve graphitizability of the finished carbon foam. The precursor polymeric foam can also include solid graphitization promoting additives to increase the thermal conductivity of the final carbon foam product. Moreover, the carbon foam can be treated with an aqueous graphitization promoting additive after the final carbonization step for increased graphitizability.

The inventive carbon foam has a ratio of compressive strength to density of at least about 7000 psi/(g/cm³), especially a ratio of compressive strength to density of at least about 8000 psi/(g/cm³). The inventive foam product advantageously has a density of from about 0.03 to about 0.6 g/cm³ and a compressive strength of at least about 2000 psi, and a porosity of between about 50% and about 95%. The cells of the carbon foam have, on average, an aspect ratio of between about 1.0 and about 1.5.

Preferably, at least about 90% of the cell volume is made of the cells having a diameter of between about 10 and about 150 microns; indeed, most preferably, at least about 95% of the cell volume is made of the cells having a diameter of between about 25 and about 95 microns. Advantageously, at least about 1% of the cell volume is made of the cells having a diameter of between about 0.8 and about 3.5 microns, more preferably, from about 2% to about 10% of the pore volume is made of the cells having a diameter of about 1 to about 2 microns.

The inventive foam can be produced by carbonizing a polymeric foam article, especially a phenolic foam, in an inert or air-excluded atmosphere. The phenolic foam should preferably have a compressive strength of at least about 100 psi.

It is to be understood that both the foregoing general description and the following detailed description provide embodiments of the invention and are intended to provide an overview or framework of understanding to nature and character of the invention as it is claimed.

### DETAILED DESCRIPTION OF THE PREFERRED EMBODIMENTS

Carbon foams in accordance with the present invention are prepared from polymeric foams, such as polyurethane foams or phenolic foams, with phenolic foams being preferred. Phenolic resins are a large family of polymers and oligomers, composed of a wide variety of structures based on the reaction products of phenols with formaldehyde. Phenolic resins are prepared by the reaction of phenol or substituted phenol with an aldehyde, especially formaldehyde, in the presence of an acidic or basic catalyst. Phenolic resin foam is a cured system composed of open and closed cells. The resins are generally aqueous resols catalyzed by sodium hydroxide at a formaldehyde-to-phenol ratio which can vary, but is preferably about 2:1. Free phenol and formaldehyde contents should be low, although urea may be used as a formaldehyde scavenger.

The foam is prepared by adjusting the water content of the resin and by adding a surfactant (e.g., an ethoxylated nonionic), a blowing agent (e.g., pentane, methylene chloride, or chlorofluorocarbon), and a catalyst (e.g., toluenesulfonic acid or phenolsulfonic acid). The sulfonic acid catalyzes the reaction, while the exotherm causes the blowing agent, emulsified in the resin, to evaporate and hence expand the foam. The surfactant controls the cell size as well as the ratio of open-to-closed cell units. Both batch and continuous processes are employed. In the continuous process, the machinery is similar to that used for continuous polyurethane foam. The properties of the foam depend mainly on density and the cell structure.

The preferred phenol is resorcinol; however, other phenols of similar kind that are able to form condensation products with aldehydes can also be used. Such phenols include monohydric and polyhydric phenols, pyrocatechol, hydroquinone, alkyl-substituted phenols, such as, for example, cresols or xylenols, polynuclear monohydric or polyhydric phenols, such as, for example, naphthols, p.p′-dihydroxydiphenyl dimethyl methane or hydroxyanthracenes.

The phenols used to make the foam starting material can also be used in admixture with non-phenolic compounds that are able to react with aldehydes in the same way as phenol.

The preferred aldehyde for use in the solution is formaldehyde. Other suitable aldehydes include those that will react with phenols in the same manner. These include, for example, acetaldehyde and benzaldehyde.

In general, the phenols and aldehydes that can be used in the process of the invention are those described in U.S. Pat. Nos. 3,960,761 and 5,047,225, the disclosures of which are incorporated herein by reference.

In order to achieve a resin-derived carbon foam with improved graphitizability, the inventive foam should be prepared with at least one graphitization promoting additive. Certain chemical additives have been shown capable of improving the graphitizability of carbon materials (D.B. Fiscbach, in Chemistry and Physics of Carbon, Volume 7, p. 83 (1971)). Some carbides and metal forming carbides act as graphitization catalysts through preferential solution and reprecipitation of disordered carbon regions to form ordered carbon regions. Whereas graphitization promoting additives containing boron increase the graphitizability of the carbon foam by modifying the foam's lattice structure through a localized interaction with the carbon-carbon bonds. Specifically, the boron additive is incorporated into the carbon foam and bonds in the carbon lattice on an atomic scale.

By the use of a graphitization promoting additive, the final carbon foam will have a more graphitic structure, which greatly improves thermal conductivity. Optimally, the inventive carbon foam will have about 0.2% to about 2% by weight of a graphitization promoting additive dispersed throughout its molecular structure. Graphitization promoting additives include metal carbides, and also certain compounds of iron, nickel and boron. Boron in particular is an effective graphitization promoting additive for the carbon foam.

The preferred method for incorporating a graphitization promoting additive such as boron into a carbon foam is to introduce the additive during the formation of the precursor resin. For instance, boric acid can be used as a catalyst for the phenol-formaldehyde polymerization reaction in the production of a phenolic novolac resin. Additionally, if a basic polymerization catalyst is used in the production of a phenolic resol resin, boric acid can be added subsequent to the resin formation to neutralize excess base catalyst. In either the acid- or base-catalyzed resin formation, the boron-containing compound is dispersed throughout the resin and becomes fully incorporated into the phenolic foam and eventually the carbon foam after carbonization.

In a second embodiment, the graphitization promoting additive is a polymer additive which is admixed with the precursor resin blend. The polymer additive can be polyvinyl chloride, polyvinyl alcohol polyacenaphthylene, polyamide, or a combination thereof. These polymers, unlike phenolic or polyurethane resins, form a graphitizable carbon when pyrolyzed. Any one of the abovementioned polymer additives will greatly improve the final graphitic structure of the carbon foam material, when incorporating in the phenolic resin precursor of the carbon foam thus resulting in improved thermal and electrical conductivities.

In yet another embodiment, boron can be incorporated into a carbon foam during the conversion of the phenolic resin to a phenolic foam. Typically, acid catalysts such as para-toluenesulfonic acid (PTSA) are used to catalyze this reaction. Boric acid can be introduced as a supplemental catalyst to assist PTSA in converting the phenolic resin to a phenolic foam while providing a sufficient quantity of boron to improve the graphitizability of the carbon foam product.

In yet another embodiment, boron can be introduced in a solid-state form during either the resin or foam preparation step to improve the graphitizability of the carbon foam product. These solid-state forms of boron include boron powder, boron carbide, and boric oxide and can also include similar solid compounds of nickel and iron.

In still another embodiment, the carbon foam can be impregnated with a graphitization promoting additive after the final carbonization step. After the carbonization of the phenolic foam to a carbon foam, the carbon foam can be treated with a solution of soluble graphitization promoting additive such as boric acid, or with a dispersion of a boron-containing solid, boron carbide or boric oxide in water.

After the graphitization promoting additive is introduced into the carbon foam, the carbon foam can be heat treated to a temperature of at least about 2000° C., to incorporate the graphitization promoting additive into the carbon foam's lattice on an atomic level. This heat treating step can be part of the carbonization process for converting the polymer foam into carbon foam, as described below.

The final concentration of boron in the carbon foam preferably should be from about 0.2% to about 2% by weight. To achieve the preferred concentration of boron in the carbon foam material, the concentration of boron in the phenolic foam should be from about 0.1% to about 1.0% by weight because the yield for conversion of phenolic foam to carbon foam is approximately about 50%. This conversion yield will result in the desired concentration of about 0.2% to about 2% by weight of boron in the carbon foam material upon carbonization of the phenolic foam.

The polymeric foam precursor prepared as described above, that is used as the starting material in the production of the inventive carbon foam, should have an initial density which mirrors the desired final density for the carbon foam to be formed. In other words, the polymeric foam should have a density of about 0.1 to about 0.8 g/cm³, more preferably about 0.1 to about 0.6 g/cm³. The cell structure of the polymeric foam should be closed with a porosity of between about 50% and about 95% and a relatively high compressive strength, i.e., on the order of at least about 100 psi, and as high as about 300 psi or higher.

In order to convert the polymeric foam to carbon foam, the foam is carbonized by heating to a temperature of from about 500° C., more preferably at least about 800° C., up to about 3200° C., in an inert or air-excluded atmosphere, such as in the presence of nitrogen. The heating rate should be controlled such that the polymeric foam is brought to the desired temperature over a period of several days, since the polymeric foam can shrink by as much as about 50% or more during carbonization. Care should be taken to ensure uniform heating of the polymeric foam article for effective carbonization.

By the use of a polymeric foam heated in an inert or air-excluded environment with the use of a graphitization catalyst, a graphitizable carbon foam is obtained, which has the approximate density of the starting polymeric foam, but a compressive strength of at least about 2000 psi and, significantly, a ratio of strength to density of at least about 7000 psi/(g/cm³), more preferably at least about 8000 psi/(g/cm³). The carbon foam has a relatively uniform distribution of isotropic cells having, on average, an aspect ratio of between about 1.0 and about 1.5.

The resulting carbon foam has a total porosity of about 50% to about 95%, more preferably about 60% to about 95% with a bimodal cell size distribution; at least about 90%, more preferably at least about 95%, of the cell volume is made of the cells of about 10 to about 150 microns in diameter, more preferably about 15 to about 95 microns in diameter, most preferably about 25 to about 95 microns in diameter, while at least about 1%, more preferably about 2% to about 10%, of the cell volume is made of the cells of about 0.8 to about 3.5 microns, more preferably about 1 to about 2 microns, in diameter. The bimodal cell structure nature of the inventive foam provides an intermediate structure between open-cell foams and closed-cell foams, limiting the fluid permeability of the foam while maintaining a foam structure. Nitrogen gas permeabilities less than 3.0 darcys, even less than 2.0 darcys, are preferred.

Typically, characteristics such as porosity and individual cell size and shape are measured optically, such as by the use of an optical microscopy using bright field illumination, and are determined using commercially available software, such as Image-Pro Software available from MediaCybernetic of Silver Springs, Md.

The cell structure of the foam is unique as compared to other foams in that it is intermediate to a closed-cell and open-cell configuration. The large cells appear to be only weakly connected to each other and connected by the fine porosity so that the foam exhibits permeability in the presence of water but does not readily absorb more viscous liquids.

Accordingly, by the practice of the present invention, carbon foams having heretofore unrecognized characteristics are prepared. These foams exhibit good graphitizability as well as high compressive strength to density ratios and have a distinctive bimodal cell structure, making them uniquely effective at applications, such as composite tooling applications.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A method for preparing a graphitizable carbon foam, comprising:
a) catalyzing a phenol-aldehyde mixture to form a phenolic resin in the presence of a graphitization promoting additive,
b) producing a phenolic foam from the phenolic resin,
c) carbonizing the phenolic foam to create a carbon foam having a carbon lattice,
d) heating the carbon foam to a temperature sufficient to incorporate the graphitization promoting additive into the carbon lattice.

2. The method of claim 1 wherein the graphitization promoting additive functions as a catalyst.

3. The method of claim 1 wherein excess catalyst is neutralized by the graphitization promoting additive.

4. The method of claim 1 wherein the graphitization promoting additive is reactively inert.

5. The method of claim 1 wherein the graphitization promoting additive comprises a metal carbide, a metal oxide, iron, nickel, boron, and combinations thereof.

6. The method of claim 5 wherein the graphitization promoting additive comprises boric acid.

7. The method of claim 5 wherein the graphitization promoting additive comprises boron and is introduced in a solid state.

8. The method of claim 7 wherein the solid-state boron is selected from the group consisting of boron powder, boron carbide, boric oxide, and combinations thereof.

9. The method of claim 1 wherein the graphitization promoting additive is a polymer additive.

10. The method of claim 9 wherein the polymer additive is selected from the group consisting of polyvinyl chloride, polyacenaphthylene, polyvinyl alcohol, polyamide, and combinations thereof.

11. The method of claim 1 wherein the graphitization promoting additive comprises boron and the concentration of boron in the phenolic foam is from about 0.1% to about 1% by weight.

12. The method of claim 1 wherein the graphitization promoting additive comprises boron and the concentration of boron in the carbon foam is from about 0.2% to about 2% by weight.

13. The method of claim 1 wherein step d) comprises heating the carbon foam material to a temperature of from about 2000° C. to about 2600° C.

14. A carbon foam comprising a graphitization promoting additive incorporated into the carbon foam's lattice structure, wherein the carbon foam has a density from about 0.03 g/cm³ to about 0.6 g/cm³ and a compressive strength of at least about 2000 psi.

15. The foam of claim 14 that has a porosity of between 50% and about 95%.

16. The foam of claim 14 wherein the cells of the carbon foam have, on average, an aspect ratio of between about 1.0 and about 1.5.

17. The foam of claim 14 wherein at least about 95% of the cell volume of the cells has a diameter of between about 25 and about 95 microns.

18. The foam of claim 14 wherein the carbon foam has a graphitization promoting additive content of from about 0.2% to about 2% by weight.

19. The foam of claim 14, wherein the graphitization promoting additive comprises boron.

20. The foam of claim 19 wherein the concentration of boron in the carbon foam is from about 0.2% to about 2% by weight.
